(19) United States
(12) Patent Application Publication
(10) Pub. No.: US 2022/0289055 A1
(43) Pub. Date: Sep. 15, 2022

(54) POSITIONING DEVICE FOR LOCATION POSITIONING OF ENERGY STORAGE CELLS

(71) Applicant: MAHLE International GmbH, Stuttgart (DE)

(72) Inventors: Julius Aktas, Bietigheim-Bissingen (DE); Stefan Moedinger, Remseck a.N. (DE); Eduard Reimer, Fellbach (DE); Karl-Ulrich Schmid-Walderich, Tuebingen (DE); Georg Votteler, Backnang (DE); Johannes Weinmann, Stuttgart (DE)

(21) Appl. No.: 17/693,347

(22) Filed: Mar. 12, 2022

(30) Foreign Application Priority Data
Mar. 12, 2021 (DE) 10 2021 202 429.7

(51) Int. Cl. B60L 53/35; B60L 53/80; H01M 50/289; H01M 50/249

(52) U.S. Cl. CPC B60L 53/35; B60L 53/80; H01M 50/289; H01M 50/249; H01M 2220/20

(57) ABSTRACT

A positioning device for location positioning of a plurality of energy storage cells of an energy storage device of a vehicle, a cover for closing such a positioning device, an energy storage device with such a positioning device, and a such cover are provided. The present disclosure is based on a general idea of providing a positioning device for energy storage cells which allows both material savings and functional integration of a number of functions.

### CROSS REFERENCE TO RELATED APPLICATIONS

This application claims priority to German patent application DE 10 2021 202 429.7, filed Mar. 12, 2021, the entire content of which is incorporated herein by reference.

### TECHNICAL FIELD

The present disclosure relates to a positioning device for location positioning of a plurality of energy storage cells in an energy storage device of a vehicle, a cover for closing such a positioning device, and an energy storage device with such a positioning device and such a cover.

### BACKGROUND

Energy stores for vehicles, especially for vehicles with electric drive units, are a core component in the electrification of individual passenger transport means. These energy storage devices can be designed as a drive battery or traction battery, which supplies an electric drive unit of the vehicle with sufficient electrical energy that is converted into kinetic energy of the vehicle by the electric drive unit. In order to provide a sufficient amount of electrical energy, such energy stores comprise a plurality of energy storage cells which are formed separately from one another.

In order to increase the acceptance of electric vehicles among the end customers, it is necessary for the energy storage device, as a core component of electrified individual passenger transport, to become more cost-effective to produce.

### SUMMARY

It is therefore an object of the disclosure to provide an improved or at least an alternative embodiment of the components of the energy store or of the energy store in itself, which improvement is particularly referred to the production costs.

The object is achieved by a positioning device, a cover for closing a positioning device, and an energy store for a vehicle as described herein.

The present disclosure is based on a general idea of providing a positioning device for energy storage cells that allows both material savings and the functional integration of a number of functions.

The positioning device according to the disclosure for location positioning of several energy storage cells of an energy storage device of a vehicle can be produced by a primary forming method, in particular by injection molding. Typically, the positioning device is designed to be thermally and electrically insulating. For this purpose, the positioning device can be made of a thermoplastic or duroplastic material, for example. The positioning device and/or parts of the positioning device can be designed as injection molded components, in particular as plastic injection molded components.

The positioning device includes a base that forms a plurality of positioning recesses into which the energy storage cells can be inserted for location positioning. The term “location positioning” can be understood here to mean that the energy storage cells can be positioned and fixed, particularly in a secure and/or shift proof way, with respect to their location relative to one another and also with respect to their location relative to the positioning device on the base. A location positioning can be characterized in that the energy storage cells do not experience any displacement of their location when the positioning device is in the inserted state when a liquid casting compound is introduced into the positioning device. It can be provided that all energy storage cells have an identical and/or the same body shape. The energy storage cells can be inserted individually, i.e. separately, in the positioning recesses. In particular, a separate positioning recess can be provided or present for each energy storage cell.

The positioning device comprises a frame which is arranged on the base and is formed peripherally around the positioning recesses. The frame can be arranged on the base by peripherally surrounding the positioning recesses, so that the frame surrounds all positioning recesses, in particular in a plan view of the base.

The base and the frame are designed in such a way that together they form an accommodating space for accommodating the plurality of energy storage cells and for accommodating a casting compound. The accommodating space has an accommodating volume, with the frame being adapted to the body shape of an energy storage cell at least in sections, in particular in a plurality of sections, in order to reduce the accommodating volume. In order to reduce the storage volume, the frame can be adapted in sections, in particular in several partial sections, to the body shape of an energy storage cell and adapted overall to the arrangement of all energy storage cells defined by the positioning recesses. In other words, the frame can create displacement geometries to reduce the required amount of casting compound or gap filler.

The base with the inserted energy storage cells can form a casting trough together with the frame, into which a liquid casting compound can be introduced. Here, the liquid casting compound can harden and solidify into a solid mass without being able to escape from this casting trough. When energy storage cells are used, that part of the accommodating volume of the accommodating space that is not filled by the energy storage cells can be referred to as the casting volume. By adapting the frame at least in sections to the body shape of an energy storage cell, the required casting volume can thus be reduced, so that less casting compound is required, and this is associated with cost and weight optimization. In addition, the required installation space is reduced, so that an integration of further functionalities is possible in terms of installation space.

In an advantageous development of the solution according to the disclosure, it is provided that the positioning device for the location positioning of energy storage cells is designed with a cylindrical, in particular circular-cylindrical body shape, and/or that the base forms a plurality of positioning recesses into which energy storage cells with a circular-cylindrical body shape can be inserted for location positioning. It can be provided that all positioning recesses for the location positioning of energy storage cells are designed with a body shape resembling a circular cylinder. The positioning recesses can be designed as circular positioning recesses.

In an advantageous further development of the solution according to the disclosure, it is provided that the frame is designed to be complementary to the body shape of an energy storage cell and/or a plurality of energy storage cells, at least in sections, in order to reduce the storage volume. In the case of energy storage cells with a body shape like a circular cylinder, the frame can form, for example, a circular cylinder segment or a plurality of circular cylinder segments.

In an advantageous development of the solution according to the disclosure, it is provided that the frame forms a plurality of circular cylinder segments, the circular cylinder segments each forming a curved inner wall section to reduce the accommodating volume, the curved inner wall sections each facing the accommodating space and delimiting the accommodating space. The frame may have multiple circular cylinder segments connected to each other to achieve displacement geometries to reduce the amount of casting compound required. The circular cylinder segments of the frame can form displacement geometries that are adapted to the arrangement of the energy storage cells in order to reduce the required quantity of casting compound or gap filler.

In an advantageous development of the solution according to the disclosure, it is provided that the frame extends away from the base in a vertical direction, with the curved inner wall sections each forming a circular arc in a cross-section transverse to the vertical direction, with the circular arc having an arc radius that is greater than or equal to half a diameter of a circular-cylindrical energy storage cell that can be inserted into the positioning recess. The arc radius can be smaller than the diameter of a circular-cylindrical energy storage cell that can be inserted into the positioning recess. A circular arc can be a circular arc segment that does not describe a complete circle. The arc radius can be determined from a center point associated with the circular arc. The center point associated with the circular arc can be defined as the point in space that is at an identical distance from every point on the circular arc. A center angle of the circular arc and/or circular arc segment can also be determined from this center point.

The diameter or outer diameter of a circular-cylindrical energy storage cell that can be inserted into the positioning recess can be determined in a cross section of the energy storage cell perpendicular to its direction of longitudinal extent and/or perpendicular to its axis of symmetry. An energy storage cell with a circular-cylindrical body shape can be referred to as a circular-cylindrical energy storage cell.

In an advantageous development of the solution according to the disclosure, it is provided that the circular arcs of the curved inner wall sections each have a central angle, the central angle of at least one curved inner wall section being less than 270°, typically less than 180°, more typically less than 90°. In contrast to a circular arc or circular arc segment, a circle has a central angle of 360®.

In an advantageous development of the solution according to the disclosure, it is provided that the positioning recesses each penetrate the base completely, and/or that the positioning recesses are each adapted to the body shape of an energy storage cell, and/or that the positioning recesses are distributed in such a way that the energy storage cells spaced from each other and spaced from the frame in the positioning recesses are positionable at locations in the accommodating space.

Through positioning recesses that completely penetrate the base the energy storage cells inserted into these positioning recesses can form a thermal connection to a temperature control plate through which fluid can flow, in particular a cooling plate through which liquid can flow, that is assigned to the positioning device. In particular, the energy storage cells inserted into these positioning recesses can directly touch such a temperature control fluid plate through which fluid can flow, at least in sections, in particular with one end face, in order to form a thermal connection.

The energy storage cells can be completely encapsulated with the casting compound with positioning recesses that are distributed in such a way that the energy storage cells can be positioned at a distance from one another and at a distance from the frame in the positioning recesses in the accommodating space. This increases the mechanical stability or resilience of the energy store and also enables improved temperature control of the energy storage cells.

The positioning recesses, each adapted to the body shape of an energy storage cell, can seal the accommodating space together with the energy storage cells, so that the casting compound cannot escape from the positioning device, in particular not from the base.

In an advantageous development of the solution according to the disclosure, it is provided that at least one fastening section is designed for fastening a fire protection device, and/or that at least one fastening section is designed for fastening a control device, and/or that at least one fastening section is designed for fastening cables and/or busbars and/or coolant lines. A fire protection device can be designed, for example, as a sheet metal and/or metallic structural part or as a non-metallic structural part, such as a mica plate, which is fastened to the frame. A fire protection device can fulfil necessary fire safety requirements. The control device may be a cell module controller (CMC). This enables functional integration of further required functions.

The fastening section for fastening a fire protection device and/or the fastening section for fastening a control device and/or the fastening section for fastening cables and/or busbars and/or coolant lines can be formed integrally with the positioning device, i.e., they form an integrally formed area or section.

In an advantageous development of the solution according to the disclosure, it is provided that the base has at least one penetrating sensor recess for accommodating a temperature sensor, and/or that at least one temperature sensor is arranged in the accommodating space, and/or that at least one temperature control tube with several separate fluid channels for temperature control of energy storage cells are at least partially arranged in the accommodating space, and/or that at least one temperature control tube with a plurality of separate fluid channels for temperature control of energy storage cells is at least partially arranged in the accommodating space, the temperature control tube being adapted at least in sections to the body shape of a circular-cylindrical energy storage cell that can be inserted into the positioning recess. A temperature control tube can be designed as a cooling tube through which liquid can flow.

A temperature control tube can be designed as an MPE flat tube (MPE=Multiport Extrusion). The temperature control tube can be made of a metallic material. A temperature control tube that is adapted at least in sections to the body shape of a circular-cylindrical energy storage cell that can be inserted into the positioning recess can have bent sections. A temperature control tube that is adapted at least in sections to the body shape of a circular-cylindrical energy storage cell that can be inserted into the positioning recess can have bent sections the bending radius of which changes periodically in direction or sign. In a longitudinal cross-section, such a configuration could also be described as wavy and/or sinusoidal.

At least one sensor recess, in particular a bore, can be formed that completely penetrates through the base, in which a temperature sensor is inserted in order to measure the temperature of a temperature control fluid plate arranged on the base through which fluid can flow. At least two sensor recesses spaced apart from one another can be formed, each of which completely penetrates the base and in each of which a temperature sensor is inserted, with the temperature sensors being arranged on the inflow and return of the temperature control medium line, in particular coolant line, of the temperature control plate, in particular cooling plate, in order to regulate the temperature control, especially cooling, to be able to regulate.

The temperature control tube, which is at least partially arranged in the accommodating space, can be equipped with a temperature control plate, in particular a cooling plate, arranged on the base, through which fluid can flow, in order to provide a mechanically more stable and/or more resistant structure. Several temperature control tubes can each be arranged at least partially in the accommodating space, each with a temperature control plate, in particular a cooling plate, through which fluid can flow, arranged on the base, in order to provide a mechanically more stable and/or more resistant structure.

In an advantageous development of the solution according to the disclosure, it is provided that the frame forms at least one injection channel on a side facing away from the accommodating space, via which a casting compound can be injected into the accommodating space, and/or that the positioning device is designed in one piece and/or in one part, and/or that the positioning device is designed in several parts, in particular in two parts, the several parts of the positioning device being connected to one another in a form-fitting manner such that together they form a labyrinth seal for sealing off the accommodating space. Provision can be made for the frame to be designed in multiple parts, in particular in two parts.

The labyrinth seal is designed in such a way that it prevents a liquid casting compound introduced into the accommodating space from being able to escape from the accommodating space. In addition, the labyrinth seal can enable tolerance compensation. The labyrinth seal can be formed by a mushroom-shaped connection.

Furthermore, the disclosure relates to a cover for closing a positioning device according to the disclosure. The cover can be produced by a primary shaping method, in particular by injection molding. Typically, the cover is designed to be thermally and electrically insulating. For this purpose, the cover can be made of a thermoplastic or duroplastic material, for example. The cover can be designed as an injection molded component, in particular as a plastic injection molded component. The cover can be designed in one piece and/or in one part.

The cover is adapted to the frame of the positioning device in such a way that it can be arranged on the frame of the positioning device in order to close off the accommodating space of the positioning device, the cover forming at least one casting compound displacer for displacing casting compound between energy storage cells and/or between energy storage cells and the frame. As a result, the required quantity of casting compound can be reduced and, in addition, the surface area of the cover, which forms a material connection with the casting compound, can be increased, so that the mechanical resistance can be increased.

In an advantageous development of the solution according to the disclosure, it is provided that the cover forms positioning recesses for a number of energy storage cells and/or that the cover forms positioning recesses for a number of energy storage cells, the positioning recesses penetrating the cover completely, with at least one contact bar being arranged on the cover, which is arranged at least in sections on at least one positioning recess such that an energy storage cell can be electrically contacted with the at least one contact bar. This improves the mechanical resistance and enables electrical interconnection of the energy storage cells. A cell contacting system can thus be formed by one or more contact bars.

In an advantageous development of the solution according to the disclosure, it is provided that the cover forms skids and/or shock skids, and/or that the cover forms sockets for screwing contact bars, and/or that the cover forms casting compound injection openings, and/or that the cover forms casting compound injection ports, each having a membrane. This enables functional integration of further required functions.

The skids and/or shock skids and/or bushings and/or casting compound injection openings can be formed integrally with the cover.

Furthermore, the disclosure relates to an energy store for a vehicle. The energy store can be a drive battery or traction battery and/or a drive accumulator or traction accumulator, which supplies an electric drive unit of the vehicle with sufficient electric energy, which is converted by the electric drive unit into kinetic energy of the vehicle.

The energy store includes a number of energy storage cells, all of which have the same body shape. Energy storage cells can be battery cells and/or accumulator cells that provide electrical energy.

Furthermore, the energy store comprises at least one positioning device according to the disclosure and at least one cover according to the disclosure, the positioning device and the cover delimiting the accommodating space for accommodating the energy storage cells and for accommodating a casting compound. The energy storage cells are positioned at a distance from one another and at a distance from the frame in the accommodating space with the positioning recesses in the base and with the positioning recesses in the cover. The space in the accommodating space that is not occupied by the energy storage cells is filled, in particular completely filled, with a hardened casting compound. The casting compound is introduced into the accommodating space in liquid form and hardens there. The casting compound can be formed from an electrically insulating material and/or from a thermally insulating material.

In an advantageous development of the solution according to the disclosure, it is provided that all energy storage cells have a circular-cylindrical body shape and/or that a temperature control plate through which a temperature control fluid can flow is arranged on a side of the base facing away from the accommodating space for temperature control of the energy storage cells, and/or that the positioning device is fixed to a temperature control plate through which a temperature control fluid can flow, for temperature control of the energy storage cells and that the energy storage device has a main housing which forms a housing inner space, the temperature control plate being inserted into the housing inner space.

A temperature control plate, as indicated above and in the following, is to be understood as a temperature control plate through which a temperature control fluid can flow. The temperature control fluid can be a temperature control liquid, in particular a cooling liquid. The temperature control fluid plate can be a cooling plate. The temperature control plate can form a number of separate fluid channels for providing a flow through the temperature control plate. The temperature control plate can be made of a metallic material.

The main body may be formed of a metallic material.

Further important features and advantages of the disclosure result from the dependent claims, from the drawings and from the associated description of the figures with reference to the drawings.

It goes without saying that the features mentioned above and those still to be explained in the following can be used not only in the respective specified combination, but also in other combinations or on their own, without departing from the scope of the present disclosure.

### BRIEF DESCRIPTION OF THE DRAWINGS

The disclosure will now be described with reference to the drawings wherein:

FIG. 1 is a perspective view of a positioning device with inserted energy storage cells,

FIG. 2 is a perspective partial view of a positioning device,

FIG. 3 is a further perspective view of a positioning device with inserted energy storage cells,

FIG. 4 is a further perspective partial view of a positioning device with inserted energy storage cells,

FIG. 5 is a further perspective view of a positioning device with inserted energy storage cells and a control device,

FIG. 6 is a further perspective view of a positioning device with inserted energy storage cells and several temperature control tubes,

FIG. 7 is a perspective view of a cover,

FIG. 8 is a perspective view of an energy store,

FIG. 9 is a further perspective view of a positioning device without energy storage cells,

FIG. 10 shows a partial section of FIG. 9, and

FIG. 11 is a perspective exploded view of an energy store.

### DESCRIPTION OF EXEMPLARY EMBODIMENTS

Exemplary embodiments of the disclosure are illustrated in the drawings and are explained in more detail in the following description, with the same reference symbols referring to identical or similar or functionally identical components.

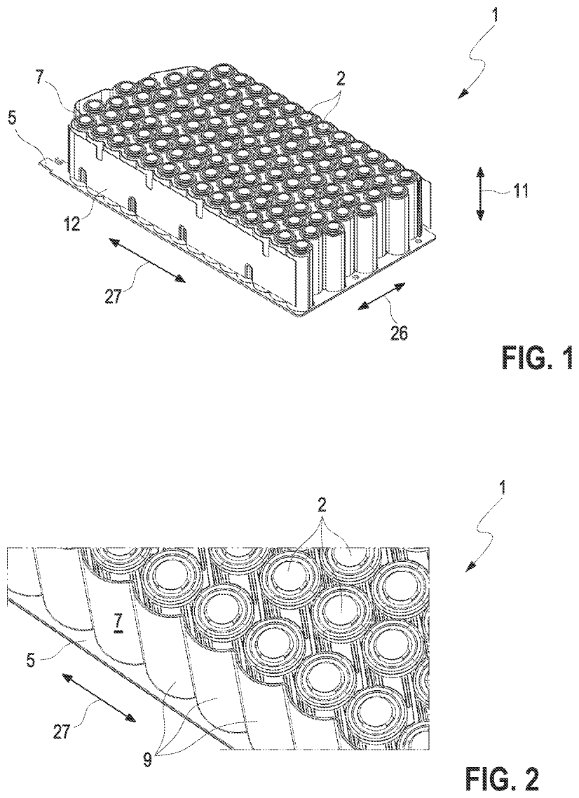

FIG. 1 shows a perspective view of a positioning device 1 with a plurality of inserted energy storage cells 2, each of which has a cylindrical body shape.

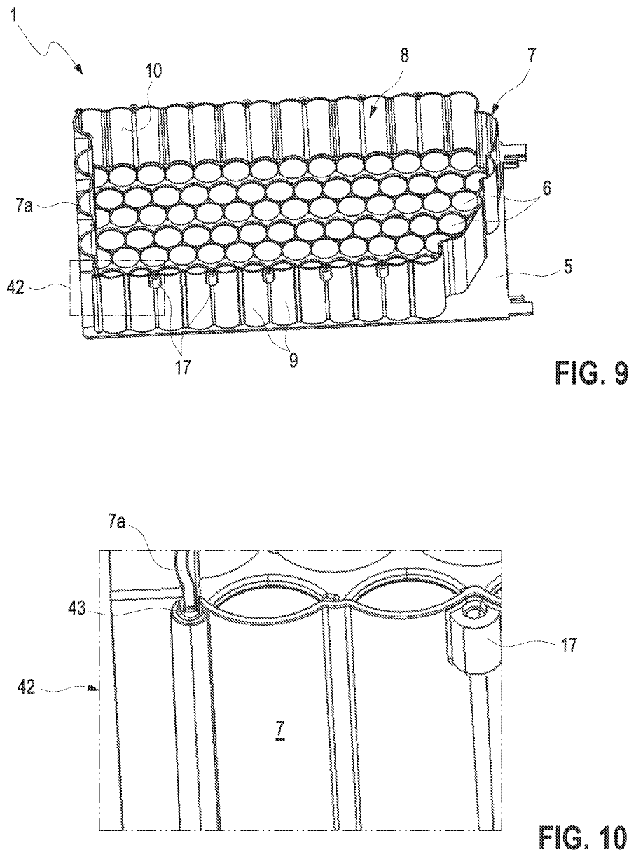

The positioning device 1 is designed for location positioning of the multiple energy storage cells 2 and includes a base 5, which forms multiple positioning recesses 6, in which the energy storage cells 2 are inserted for location positioning. FIG. 9 shows the positioning recesses 6 adapted to the body shape of the energy storage cells 2 without the energy storage cells 2 being inserted. Furthermore, it can be clearly seen in FIG. 9 that the positioning device 1 comprises a frame 7 which is arranged on the base 5 and is formed around the positioning recesses 6. As shown in FIG. 1, the frame 7 is formed to extend away from the base 5 in a height direction 11. The base extends essentially in the form of a plate in a plane that is parallel to a plane that is spanned by a transverse direction 26 and a longitudinal direction 27. The transverse direction 26 and a longitudinal direction 27 are each aligned transversely and/or perpendicularly to the vertical direction 11.

The base 5 and the frame 7 are designed in such a way that together they form an accommodating space 8, which is clearly visible in FIG. 9, for accommodating the plurality of energy storage cells 2 and for accommodating a casting compound. The casting compound is not shown explicitly in any of the figures. The accommodating space has an accommodating volume. The part of the accommodating space that is not filled by the energy storage cells is completely filled with a liquid casting compound which then hardens to form a solid body.

FIG. 9 also clearly shows that the positioning recesses 6 completely pass through the base 5, respectively. A comparison of FIG. 1 and FIG. 9 also shows that the positioning recesses 6 are each adapted to the body shape of an energy storage cell 2.

FIG. 2 clearly shows that the positioning recesses 6 are distributed in such a way that the energy storage cells 2 are positioned at a distance from one another and at a distance from the frame 7 in the positioning recesses 6 in the accommodating space 8.

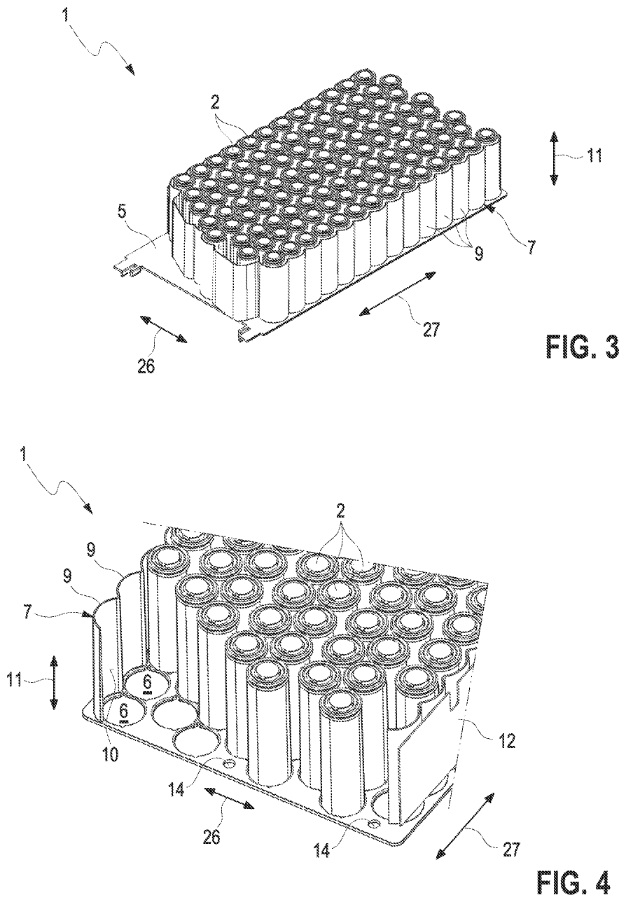

The frame 7 is designed to be adapted at least in sections to the body shape of an energy storage cell 2 in order to reduce the accommodating volume. This adaptation can be seen particularly well in FIGS. 2, 3, and 4.

To reduce the storage volume, the frame 7 is designed at least in sections to complement the circular-cylindrical body shape of an energy storage cell 2 and/or a plurality of energy storage cells 2.

The frame 7 forms a plurality of circular cylinder segments 9 which each form a curved inner wall section 10. The curved inner wall section 10 of a circular cylinder segment 9 can be seen clearly in FIG. 4 or FIG. 9. The curved inner wall sections 10 each face the accommodating space 8 and delimit it. The circular cylinder segments 9 of the frame 7 form displacement geometries that are adapted to the arrangement of the energy storage cells in order to reduce the required quantity of casting compound or gap filler.

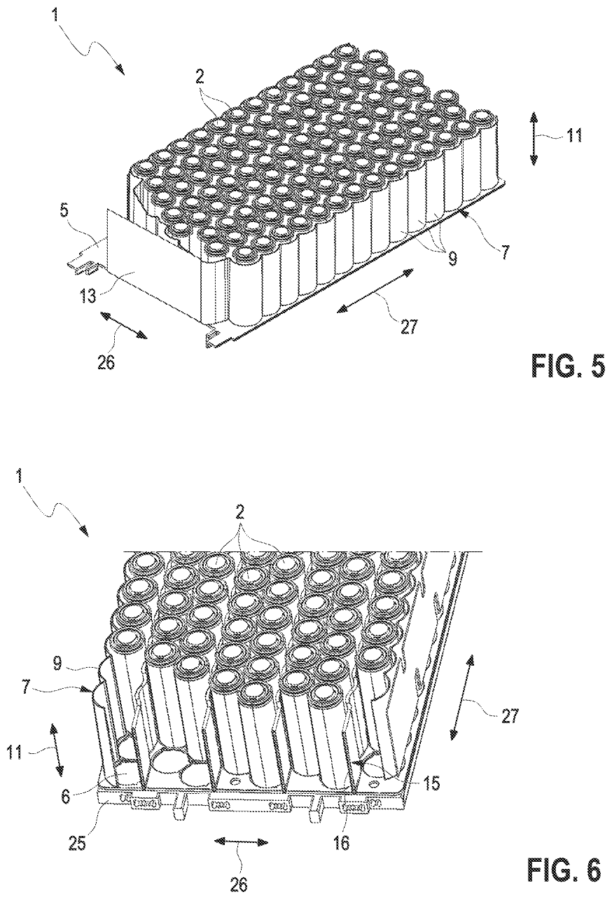

As shown in FIGS. 1, 4, 6, and 8, the frame 7 can form at least one fastening section for fastening a fire protection device 12, for example. As shown in FIGS. 5 and 8, the positioning device 1 can, for example, form at least one fastening section for fastening a control device 13.

The base 5 can have at least one or more penetrating sensor recesses 14 for accommodating a temperature sensor. These sensor recesses 14 are clearly visible in FIG. 4, for example. Since the sensor recesses 14 completely pass through the base 5, temperature sensors (not shown) can be arranged in these sensor recesses 14 in order to measure, for example, the temperature of a temperature control plate 25 arranged on the base 5. Such a temperature control plate 25 through which fluid can flow is indicated by way of example in FIGS. 6, 8, and 11.

As shown in FIG. 6, at least one temperature control tube 15 with a plurality of separate fluid channels 16 for temperature control of energy storage cells 2 can be at least partially arranged in the accommodating space 8. Such a temperature control tube 15 can be adapted at least in sections to the body shape of the circular-cylindrical energy storage cell 2 and can have a bent and/or curved configuration at least in sections. The temperature control tubes 15 are embedded together with the energy storage cells 2 in the casting compound, which is not shown. The temperature control tubes 15 can thus increase not only a temperature control effect, in particular a cooling effect, on the energy storage cells 2 but also the mechanical resistance of the arrangement. The temperature control tubes 15 can be mechanically and/or fluidically connected to the temperature control plate 25.

The frame 7 can form at least one injection channel 17 on a side facing away from the accommodating space 8, via which a casting compound can be injected into the accommodating space 8. The injection channels 17 are shown in FIGS. 8, 9, and 10 by way of example.

The positioning device 1 can be designed in one piece and/or in one part. As indicated by way of example in FIGS. 9 and 10, the positioning device 1 can be designed in several parts, in particular in two parts, with the several frame parts 7, 7a of the positioning device 1 being positively interconnected in such a way that together they form a labyrinth seal 43 for sealing the accommodating space 8. FIG. 10 shows an enlarged detail 42 of FIG. 9.

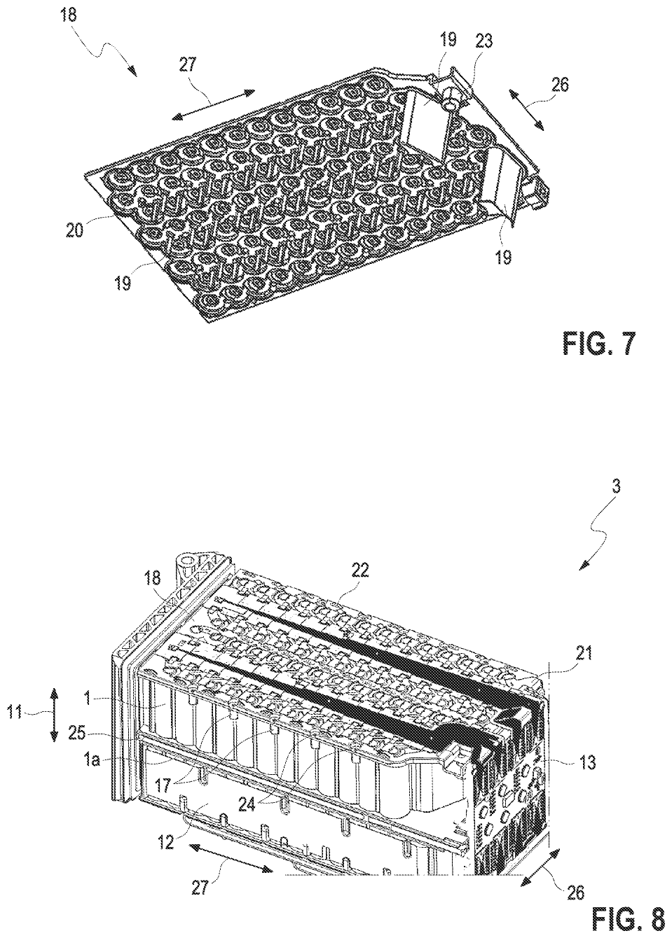

FIG. 7 shows a cover 18 for closing a positioning device 1. The cover 18 is adapted to the frame 7 of the positioning device 1 in such a way that it can be placed on the frame 7 of the positioning device 1, as shown in FIG. 8 by way of example, in order to close the accommodating space 8 of the positioning device 1. The cover 18 forms at least one casting compound displacer 19 for displacing casting compound between energy storage cells 2 and/or between energy storage cells 2 and frame 7.

The cover 18 can form a plurality of positioning recesses 20 for a plurality of energy storage cells 2, with the positioning recesses 20 passing through the cover 18. At least one contact bar 21 can be arranged on the cover 18, which is arranged at least in sections on at least one positioning recess 20 such that an energy storage cell 2 can be electrically contacted with the at least one contact bar 21. The contact bar 21 can be seen clearly in FIG. 8, for example.

The cover 18 can form skids 22 and/or shock skids 22. The cover 18 can form sockets 23 for screwing contact bars 21. The cover 18 can form casting compound injection openings 24. The cover 18 can form casting compound injection openings 24, each of which has a membrane (not shown). The casting compound injection openings 24 can be fluidically connected to corresponding injection channels 17 of the positioning device 1 in order to introduce a casting compound into the accommodating space 8.

A positioning device 1 is shown with inserted energy storage cells 2 and with a cover 18 in place, wherein the accommodating space 8 which is not filled by the energy storage cells 2 but with a hardened casting compound can be referred to as an energy storage stack 40 or 41.

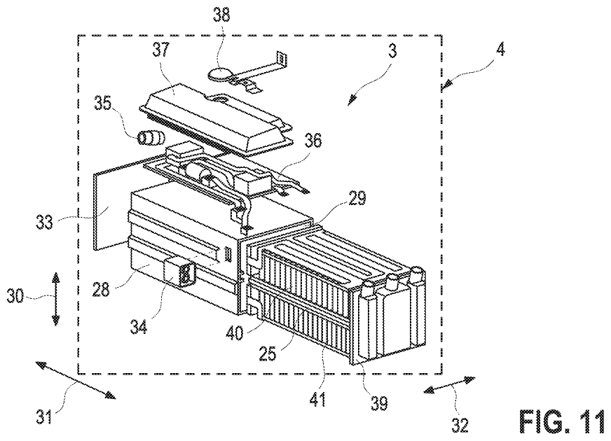

FIG. 11 schematically shows a vehicle 4 which has an energy store 3. The energy store 3 comprises a main housing 28 into which the arrangement shown in FIG. 8 can be inserted in the manner of a drawer.

The arrangement of FIGS. 8 and 11 comprises two energy storage stacks 40 or 41 which are fixed to a temperature control plate 25, the temperature control plate 25 being arranged between the two energy storage stacks 40 or 41 with respect to a height direction 30 of the housing. The arrangement of FIG. 8 can be inserted along a longitudinal direction 31 of the housing into a housing inner space 29 formed by the main housing 28 in order to form a positive connection with the main housing 28. The height direction 30 of the housing and the longitudinal direction 31 of the housing are each aligned perpendicularly and/or transversely to the transverse direction 32 of the housing. The main housing 28 can be closed at one end with an end plate 33, whereas the end of the main housing 28 opposite this end can be closed by a front plate 39 with temperature control fluid connections. The supply and/or flow of fluid through the temperature control plate 25 can be achieved via the temperature control fluid connections. The energy store 3 can have a high-voltage connection 35 and/or a low-voltage connection 36 and/or an energy storage management unit (or battery junction box) 36. A protective cover 37 for protecting the energy storage management unit (or battery junction box) 36 can be formed. The protective cover 37 can include a pressure compensation element and/or a bursting element 38. The low-voltage connector 36 can be fixed to the protective cover 37 while the high-voltage connector 35 can be arranged on the main housing 28.

The main housing 28 and/or the end plate 33 and/or the front plate 39 and/or the protective cover 37 can be formed from a metallic material. These parts can be bonded to one another, in particular by laser welding and/or soldering. These parts can be formed, for example, by extrusion and/or stamping/bending.

It is understood that the foregoing description is that of the exemplary embodiments of the disclosure and that various changes and modifications may be made thereto without departing from the spirit and scope of the disclosure as defined in the appended claims.

What is claimed is:

1. A positioning device for location positioning a plurality of energy storage cells in an energy storage device of a vehicle, the positioning device comprising:
a base which forms a plurality of positioning recesses into which the energy storage cells can be inserted for location positioning; and
a frame which is arranged on the base and is formed peripherally around the positioning recesses;
wherein the base and the frame are designed in such a way that together they form an accommodating space for accommodating the plurality of energy storage cells and for accommodating a casting compound,
wherein the accommodating space has an accommodating volume, and
wherein the frame is designed to be adapted at least in sections to the body shape of an energy storage cell in order to reduce the accommodating volume.

2. The positioning device of claim 1, wherein:
the positioning device for location positioning of energy storage cells (2) is designed with a cylindrical body shape, and/or
the base forms a plurality of positioning recesses into which energy storage cells with a circular-cylindrical body shape can be inserted for location positioning.

3. The positioning device of claim 1, wherein the frame is designed to reduce the accommodating volume, at least in sections, to complement the body shape of an energy storage cell and/or a plurality of energy storage cells.

4. The positioning device of claim 1, wherein:
the frame forms a plurality of circular cylinder segments,
the circular cylinder segments each forming a curved inner wall section to reduce the accommodating volume, and
the curved inner wall sections each facing the accommodating space and delimiting the accommodating space.

5. The positioning device of claim 4, wherein:
the frame extends away from the base in a height direction,
the curved inner wall sections each forming a circular arc in a cross-section transverse to the height direction, and
the circular arc having an arc radius which is greater than or equal to half the diameter of a circular-cylindrical energy storage cell which can be inserted into the positioning recess.

6. The positioning device of claim 5, wherein the circular arcs of the curved inner wall sections each have a central angle, and
wherein the central angle of at least one curved inner wall section is less than 270°, typically less than 180°, more typically less than 90°.

7. The positioning device of claim 1, wherein:
the positioning recesses each pass through the base completely, and/or
the positioning recesses are each adapted to the body shape of an energy storage cell, and/or
the positioning recesses are distributed in such a way that the energy storage cells can be positioned in the positioning recesses in the accommodating space at a distance from one another and at a distance from the frame.

8. The positioning device of claim 1, wherein:
at least one fastening section is designed for fastening a fire protection device, and/or
at least one fastening section is designed for fastening a control device, and/or
at least one fastening section is designed for fastening cables and/or busbars and/or coolant lines.

9. The positioning device of claim 1, wherein:
the base has at least one pass-through sensor recess for accommodating a temperature sensor, and/or
at least one temperature sensor is arranged in the accommodating space, and/or
at least one temperature control tube with a plurality of separate fluid channels for temperature control of energy storage cells is at least partially arranged in the accommodating space, and/or
at least one temperature control tube with a plurality of separate fluid channels for temperature control of energy storage cells is arranged at least partially in the accommodating space, the temperature control tube being adapted at least in sections to the body shape of a circular-cylindrical energy storage cell which is insertable in the positioning recess.

10. The positioning device of claim 1, wherein:
the frame forms at least one injection channel on a side facing away from the accommodating space, via which a casting compound can be injected into the accommodating space, and/or
the positioning device is designed in one piece and/or in one part, and/or
the positioning device is designed in several parts, in particular in two parts, the several parts of the positioning device being positively interconnected in such a way that together they form a labyrinth seal for sealing the accommodating space.

11. A cover for closing a positioning device according to claim 1, wherein:
the cover is adapted to the frame of the positioning device in such a way that it can be arranged on the frame of the positioning device in order to close off the accommodating space of the positioning device, and
the cover forms at least one casting compound displacer for displacing casting compound between energy storage cells and/or between energy storage cells and the frame.

12. The cover of claim 11, wherein:
the cover forms positioning recesses for a plurality of energy storage cells, and/or
the cover forms positioning recesses for a plurality of energy storage cells, the positioning recesses completely penetrating the cover, at least one contact bar being arranged on the cover which is at least partially arranged on at least one positioning recess in such a way that an energy storage cell can be electrically contacted with the at least one contact bar.

13. The cover of claim 11, wherein:
the cover forms skids and/or shock skids, and/or
the cover forms sockets for screwing contact bars, and/or
the cover forms casting compound injection openings, and/or
the cover forms casting compound injection openings, each having a membrane.

14. An energy store for a vehicle, the energy store comprising:
several energy storage cells, all of which have the same body shape;
at least one positioning device according to claim 1; and
at least one cover, the cover being adapted to the frame of the positioning device in such a way that it can be arranged on the frame of the positioning device in order to close off the accommodating space of the positioning device, and the cover forming at least one casting compound displacer for displacing casting compound between energy storage cells and/or between energy storage cells and the frame, and
wherein the space in the accommodating space not occupied by the energy storage cells is filled with a hardened casting compound.

15. The energy store of claim 14, wherein:
the positioning device and the cover delimit the accommodating space for accommodating the energy storage cells and for accommodating a casting compound, and
the energy storage cells are positioned at a distance from one another and at a distance from the frame in the accommodating space with the positioning recesses in the base and with the positioning recesses in the cover.

16. The energy store of claim 14, wherein:
all energy storage cells have a circular cylinder-like body shape, and/or
a temperature control plate through which a temperature control fluid can flow is arranged on a side of the base facing away from the accommodating space for temperature control of the energy storage cells, and/or
the positioning device is fixed to a temperature control plate through which a temperature control fluid can flow for temperature control of the energy storage cells and in that the energy storage device has a main housing which forms a housing inner space, the temperature control plate being inserted into the housing inner space.
